(19) United States
(12) Patent Application Publication
(10) Pub. No.: US 2025/0212028 A1
(43) Pub. Date: Jun. 26, 2025

(54) PRECISE PROTECTION OF SHARED MEDIUM BASED ON PAYLOAD LENGTH OF A WIRELESS PERSONAL AREA NETWORK (WPAN) PACKET

(71) Applicant: Cypress Semiconductor Corporation, San Jose, CA (US)

(72) Inventors: Sandeep Sarma Munukutla, Bangalore (IN); Raghavendra Kencharla, Bangalore (IN)

(73) Assignee: Cypress Semiconductor Corporation, San Jose, CA (US)

(21) Appl. No.: 18/393,373

(22) Filed: Dec. 21, 2023

(51) Int. Cl. H04W 24/08; H04W 74/08; H04W 74/0816; H04W 84/12

(52) U.S. Cl. CPC H04W 24/08; H04W 74/0816; H04W 74/0866; H04W 84/12

(57) ABSTRACT

Methods and systems for precise protection of a shared medium based on payload length of a WPAN packet. The disclosed method includes, among other things, monitoring, by a wireless local area network (WLAN) sub-system, a frequency band for wireless personal area network (WPAN) activity from a WPAN sub-system, identifying, from the WPAN activity, a WPAN packet transmitted during a first time slot, obtaining, from WPAN packet, a payload length of the WPAN packet, and interrupting, by the WLAN sub-system, the WPAN activity to transmit at least a portion of a first WLAN packet within a remainder of the first time slot.

### TECHNICAL FIELD

This disclosure relates to wireless devices and, more specifically, to precise protection of shared medium based on payload length of a wireless personal area network (WPAN) packet.

### BACKGROUND

Multiple wireless devices using different communication protocols may share a common wireless medium. For example, Wireless Personal Area Network (WPAN) technologies, including Bluetooth® (BT), Bluetooth® Low Energy (BLE), Zigbee®, infrared, and Wireless Local Area Network (WLAN) technologies, including Wi-Fi™ share a common wireless medium in a specific gigahertz (GHz) frequency band.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary wireless system, in accordance with implementations of the present disclosure.

FIGS. 2A and 2B is an exemplary diagram of a WPAN packet and header, in accordance with implementations of the present disclosure.

FIGS. 3A and 3B depicts wireless activity over a shared medium, in accordance with implementations of the present disclosure.

FIGS. 4A and 4B depicts wireless activity over a shared medium, in accordance with implementations of the present disclosure.

FIG. 5 depicts a flow diagram of an example method for precise protection of a shared medium based on payload length of a WPAN packet, in accordance with implementations of the present disclosure.

### DETAILED DESCRIPTION

Aspects of the present disclosure relate to precise protection of shared medium based on payload length of a wireless personal area network (WPAN) packet. Co-existence refers to when a WLAN sub-system coexist with another wireless technology (e.g., WPAN sub-system), in a shared environment, possibly on a single piece of hardware or within close proximity. Due to the co-existence of the WLAN sub-system and WPAN sub-system, their corresponding radios may interfere with one another when transmitting data on the same channel of a frequency band (e.g., an Industrial, Scientific, and Medical (ISM) frequency band) herein referred to as a shared medium. Typically, time division multiplexing (TDM) is implemented on WLAN and WPAN sub-systems having controllers with low passive isolation to manage co-existence. More specifically, TDM refers to a method of dividing the channel utilized by both the WLAN sub-system and WPAN sub-system into time slots and assigning each sub-system (e.g., WLAN and WPAN sub-system) a specific time slot to transmit. This prevents WLAN and WPAN sub-systems from interfering with each other, even if they are operating on the same radio channel. Low passive isolation refers to the amount of isolation between the WLAN and WPAN radios which allows for more efficient use of the channel.

In some instances, to further mitigate against potential interference, a clear to send to self (CTS-2-Self) frame may be transmitted by the WLAN sub-system to itself. The CTS-to-Self frame includes an expiration time of the co-existing radio's activity (e.g., imminent WPAN sub-system) and indicates to other sub-systems (e.g., peer sub-systems) that the channel is being occupied for the duration of the expiration time. This helps notify the peer sub-systems that they should not transmit during this time, thereby avoiding collisions and maintaining a Modulation and Coding Scheme (MCS) index. MCS index defines the data rates, modulation, and error correction used for transmission. Maintaining a higher MCS index is vital for optimal performance and throughput. If packets are lost due to collisions, peers may assume a lower MCS index (i.e., more robust but lower throughput) is required to maintain reliable communication.

The expiration time of the imminent WPAN sub-system included in the CTS-2-Self frame is based on a transmission duration of the imminent WPAN sub-system, an inter-frame space (IFS), and a reception duration of the imminent WPAN sub-system. The transmission duration is uniformed to make it easier for receivers to synchronize their clocks with the transmitter ensuring that they can accurately capture and demodulate the incoming signals. IFS is a specific amount of time that must elapse between frames to prevent collisions and to allow the receiver to prepare for the next frame. The reception duration, which may vary, refers to the length of time it takes for a receiver to receive and process a received signal. Due to the fact that reception duration varies, reception duration is estimated. Estimating the reception duration of the imminent WPAN sub-system is typically difficult because it is based on a history of reception durations of the imminent WPAN sub-system, distance between the transmitter and receiver of the imminent WPAN sub-system reception, presence of obstacles, etc. Since the reception duration of the imminent WPAN sub-system is not always accurate, the actual reception duration of the imminent WPAN sub-system may be longer or shorter than predicted.

Due to the inaccuracies of the estimated reception duration of the imminent WPAN sub-system, the expiration time of the imminent WPAN sub-system included in the CTS-2-Self frame may be shorter than the actual expiration time of the imminent WPAN sub-system resulting in under protection of the channel or longer than the actual expiration time of the imminent WPAN sub-system resulting in over protection of the channel. Under-protection occurs when the WLAN sub-system does not protect the channel for long enough, which allows a WPAN sub-system to transmit data and interfere with the WLAN sub-system or other WPAN sub-systems. This can lead to missed packets, scaling down of the MCS index for subsequent retries, and degraded performance for the WLAN. Over-protection occurs when the WLAN sub-system protects the channel for longer than necessary, which prevents a WPAN sub-system from transmitting data and reduces the overall efficiency of the channel. Under-protection and over-protection becomes increasingly more challenging when WLAN sub-system co-exists with WPAN sub-systems functioning in a mode that prioritizes range and reliability over data rate (e.g., LE S=8 PHY of a BT) due to the varying WPAN reception durations (e.g., ranging from 800 μs to 17 ms).

Aspects and embodiments of the present disclosure address these and other limitations of the existing technology by sampling payload length of a WPAN packet transmitting over the shared medium to provide precise protection of shared medium. More specifically, when a parameter of the WPAN sub-system indicates that a number of connection events can be skip, the WLAN sub-system monitors the shared medium for WPAN activity. WLAN sub-system identifies a WPAN packet being transmitted over the shared medium. WLAN sub-system determines whether the WPAN packet is being transmitted over the shared medium for the first time. In response to the WPAN packet is being transmitted over the shared medium for the first time, the WLAN sub-system transmits a CTS-2-Self frame with an expiration time suitable for an empty payload. The expiration time suitable for an empty payload provides the WLAN sub-system sufficient time to obtain from a header of the WPAN packet a payload length. After the expiration time of the transmitted CTS-2-Self frame, WLAN sub-system interrupts the WPAN sub-system for WLAN activity, such as transmitting a WLAN packet or a portion of a WLAN packet. Typically, the WLAN sub-system only interrupts the WPAN sub-system for a reminder of the time slot allocated to the WPAN sub-system.

During a subsequent time slot allocated to the WPAN sub-system, WLAN sub-system monitors the shared medium for WPAN activity. WLAN sub-system identifies a WPAN packet being transmitted over the shared medium. WLAN sub-system determines whether the WPAN packet is being transmitted over the shared medium for the first time. In response to the WPAN packet being transmitted over the shared medium for the second time (e.g., retransmission of the WPAN packet), WLAN sub-system transmits a CTS-2-Self frame with an expiration time suitable for the payload length obtained from the first transmission of the WPAN packet. In some embodiments, WLAN sub-system may obtain from a header of the retransmitted WPAN packet an indication that another WPAN packet is expected within the current time slot. In response to determining that another WPAN packet is expected within the current time slot, WLAN sub-system transmits another CTS-2-Self frame with an expiration time suitable for the payload length obtained from the first transmission of the WPAN packet. Simply, WLAN sub-system monitors each additional WPAN packet transmitted within the current time slot to determine whether there is an indication that another WPAN packet is expected to transmit another CTS-2-Self frame. In response to determining that another WPAN packet is not expected within the current time slot, WLAN sub-system utilizes the remainder of the current time slot for WLAN activity, such as transmitting a WLAN packet or a portion of a WLAN packet.

Aspects of the present disclosure overcome these deficiencies and others by sampling payload length from the first transmission of the WPAN packet to transmit more precise CTS-2-Self frames according to the actual require duration of the WPAN packet, thereby providing more efficient sharing of the medium.

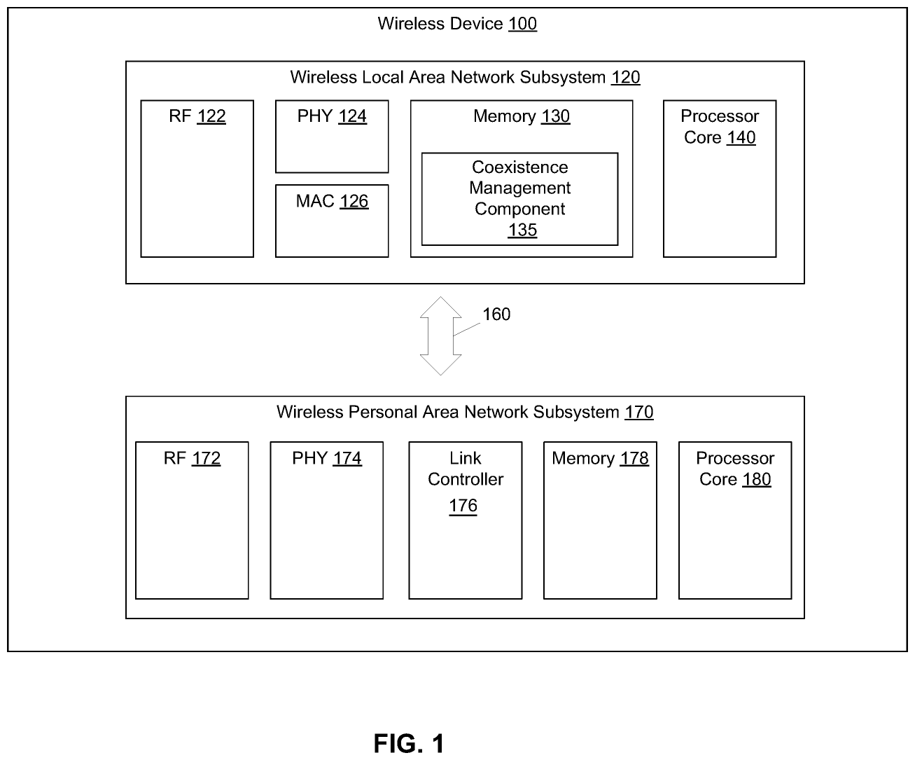

FIG. 1 is a block diagram of an exemplary wireless device 100, in accordance with implementations of the present disclosure. Wireless device 100 may include a WLAN sub-system 120 and a WPAN sub-system 170.

WLAN sub-system 120 includes, but is not limited to, a radio frequency front-end circuitry (RF) 122, a physical layer (PHY) 124, a media access control layer (MAC) 126, a memory 130, and a processor 140.

RF 122 is responsible for handling the radio signals involved in WLAN communication. RF 122 is coupled to one or more antennas of the wireless device 100 which receives and transmits radio signals. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters selects the appropriate frequency bands, such as 2.4 GHz or 5 GHz. The one or more switches alternate between transmission and reception modes in instances where a single antenna is used for both transmitting and receiving. In some embodiments, RF 122 may be a single component for multiple frequency bands or multiple components for each of the frequency bands.

PHY 124 is configured to transmit and receive radio signals over a frequency band (e.g., 2.4 GHz and/or 5 GHz bands). Additionally, PHY 124 is responsible for modulating data bits into a radio signal that can be transmitted, coordinating channel access with other wireless device (e.g., WLAN sub-systems or WLAN devices), and detecting/correcting errors that may occur during transmission. MAC 126 is responsible for managing and maintaining wireless communications, such as, Wi-Fi™. In particular, MAC 126 encapsulates data into frames with specific MAC addresses for transmission and decapsulation, employs protocol to manage medium access and minimize data transmission collisions, implements power-saving protocols to manage the energy use of the network interface, and, among other responsibilities, manages fair bandwidth allocation among all connected devices. Processor 140 is responsible for executing instructions stored in memory 130. The instructions, among other things, manages communication protocols, processing signals, coexistence strategies, etc. Memory 130 includes, but is not limited to, one or more volatile memory and/or non-volatile memory used for store instructions, firmware, operational data, etc.

WPAN sub-system 170 includes, but is not limited to, a RF 172, a PHY 174, a link controller 176, a memory 178, and a processor 180. Processor 180 is responsible for executing instructions stored in memory 178. Memory 178 includes, but is not limited to, one or more volatile memory and/or non-volatile memory.

RF 172, similar to RF 122 of WLAN sub-system 120, is responsible for handling the radio signals involved in WPAN communication (e.g., Bluetooth® (BT), BLE, Zigbee®, Z-wave™, and the like). In some embodiments, RF 172 is coupled to an antenna of the one or more antennas of the wireless device 100 which receives and transmits radio signals. In some embodiments, RF 172 is coupled to an antenna separate and apart from the one or more antennas of the wireless device 100 coupled to RF 122 of WLAN sub-system. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters ensures that the WPAN sub-system 170 operates within its designated frequency band (e.g., 2.4 GHz band) and minimizes interference from other RF sources. The one or more switches alternate between transmission and reception modes in instances where a single antenna is used for both transmitting and receiving.

PHY 174 is configured to transmit and receive radio signals over a frequency band (e.g., 2.4 GHz) to enable wireless communication between other WPAN sub-systems and/or WLAN sub-systems. PHY 174 uses a variety of modulation schemes to achieve specific data rates, and employs various techniques to improve the reliability of the communication, such as error detection and correction, frequency hopping, and time-division duplexing. Link controller 176 implements a link layer of a WPAN protocol stack and is responsible for transmitting and receiving data packets, managing the physical link, and handling errors. Link controller 176 interacts with a link manager, stored in memory 178, used to implement power saving and security aspects of the link layer protocol. Thus, the link manager provides information about the link status and to receive instructions.

WPAN protocol stack includes lower layers implemented by various components of the WPAN sub-system and/or device and higher layers implemented by a host. The lower layers include, for example, the physical layer implemented by PHY 174, and link layer implemented by link controller 176. The higher layers include, for example, a logical link control and adaptation (L2CAP) layer, an attribute protocol (ATT) layer, a generic attribute profile (GATT) layer, a security manager protocol (SMP) layer, and a generic access profile (GAP) layer. L2CAP layer provides crucial services for communication between WPAN sub-systems and/or devices. ATT layer provides a standardized approach to accessing and manipulating data on WPAN sub-systems and/or devices. GATT layer defines a hierarchical structure of attributes, organized into services and characteristics, providing a consistent and organized way to access and manipulate data related to specific WPAN applications. SMIP layer safeguards communication between WPAN sub-systems and/or devices by establishing secure connections and protecting data from unauthorized access. GAP layer facilitates basic communication and discovery for sub-systems and/or devices by providing essential services, common features, and advertising and scanning capabilities.

Interface 160 refers to a communication protocol used to facilitate coexistence of the WLAN sub-system 120 and the WPAN sub-system 170, especially in situations where the WLAN sub-system 120 and the WPAN sub-system 170 operate in overlapping frequency band (e.g., 2.4 GHz band), herein referred to as “a shared medium.” Interface 160, for example, may be a 2-wire serial enhanced coexistence interface (SECI) or 3-wire generic coexistence interface (GCI). Interface 160 serves as communication channels between the WLAN sub-system 120 and the WPAN sub-system 170, allowing them to coordinate their operation. In particular, managing timing of transmissions, power levels, and channel selection.

Existing coexistence strategies stored on memory 130 of WLAN sub-system 120, as noted above, when executed by the processor 140, manages the shared medium by using TDM to allocate specific time slots for transmission by the WLAN sub-system 120 and WPAN sub-system 170, ensuring coexistence without interfering with each other. The existing coexistence strategies, when executed by processor 140, causes the WLAN sub-system 120 to send CTS-2-Self frames with an expiration time associated with transmission of a WPAN packet of the WPAN sub-system 170 to itself, allowing the WLAN sub-system 120 to avoid transmitting during that time.

Memory 130 may include a coexistence management component 135. In some embodiments, coexistence management component 135 may be stored on memory 178 and executed by processor 180. In some embodiments, coexistence management component 135 may be stored in other components of wireless device 100 and executed by processor 140 and/or 180. In some embodiments, coexistence management component 135 may be stored externally (i.e., outside the wireless device) and executed by processor 140, 180, and/or an external processor.

Coexistence management component 135, when executed, determines whether a slave latency of the WPAN sub-system 170 is not zero. Slave latency of the WPAN sub-system 170 is a configuration parameter that indicates a predetermined number of connection intervals that may be skipped. Accordingly, coexistence management component 135, when executed by processor 140, may decide to interrupt the use of the shared medium from the WPAN sub-system 170 and provide it to WLAN sub-system 120. As a result, performance of the WPAN sub-system 170 should not be affected, since there is at least one more retry attempt for the WPAN sub-system 170 to meet latency requirements associated with the slave latency.

Once coexistence management component 135 determines that slave latency of WPAN sub-system 170 is not zero, coexistence management component 135 monitors the shared medium for WPAN activity from WPAN sub-system 170. Coexistence management component 135 may identify, from the WPAN activity, a WPAN packet. Coexistence management component 135 may determine whether WPAN packet is being transmitted for the first time by the WPAN sub-system 170 during a time slot (e.g., first time slot). In some embodiments, to determine that the WPAN packet is being transmitted for the first time includes identifying, from WPAN packet, whether a sequence number is zero. In some embodiments, to determine that the WPAN packet is being transmitted for the first time includes identifying, from WPAN packet, whether a retransmission flag is set to zero indicating that this is the first transmission of the WPAN packet. Other methods of determining whether WPAN packet is being transmitted for the first time by the WPAN sub-system 170 is considered.

If WPAN packet is being transmitted for the first time, coexistence management component 135 transmits a CTS-2-Self frame with an expiration time in which a reception duration of the expiration time corresponds to an empty payload (e.g., sampling CTS-2-Self frame). The reception duration corresponding to an empty packet has a duration substantially equal to a predetermined amount of time necessary for a preamble and a header of the WPAN packet to be received and not the payload since it is empty.

Coexistence management component 135, in view of an expiration time associated with the sampling CTS-2-Self frame, reduces WPAN activity of the WPAN sub-system 170 on the shared medium. During this time, coexistence management component 135 obtains a payload length from the header of the WPAN packet. As will be discussed in detail below, the header includes various bits including a set of bits containing payload length. The expiration time of the sampling CTS-2-Self frame provides the coexistence management component 135 ample time to perform data de-whitening to access the set of bits providing of the header containing the payload length and obtain the payload length. At the end of the expiration time of the sampling CTS-2-Self frame, the WLAN sub-system 120 may interrupt WPAN activity of the WPAN sub-system 170 for WLAN activity, such as transmitting a WLAN packet or a portion of a WLAN packet, during a remainder of the time slot.

Coexistence management component 135 monitors the shared medium for WPAN activity from WPAN sub-system 170. Coexistence management component 135 may identify, from the WPAN activity, re-transmission of the WPAN packet. In some embodiments, to identify the retransmission of the WPAN packet includes determining whether a sequence number of the WPAN packet is not zero. In some embodiments, to identify the retransmission of the WPAN packet includes determining whether a retransmission flag is set indicating that this is not the first transmission of the WPAN packet. Other methods of identifying the retransmission of the WPAN packet is considered.

During retransmission of the WPAN packet, coexistence management component 135 transmits a CTS-2-Self frame with an expiration time in which the reception duration corresponds to the payload length obtained from the header of the previous transmission of the WPAN packet. (e.g., precise CTS-2-Self frame). The reception duration corresponding to the payload length obtained from the header of the previous transmission of the WPAN packet is an amount of time necessary for a receiver to receive the payload of the WPAN packet. For example, the reception duration necessary to receive the payload of the WPAN packet may be calculated by based on the payload length and a transmission rate. The precise CTS-2-Self frame provides the WPAN sub-system 170 the precise amount of time to prevent under and/or over protection. At the end of the expiration time of the precise CTS-2-Self frame, the WLAN sub-system 120 may allocate the remainder of the time slot for WLAN activity, such as transmitting a WLAN packet or a portion of a WLAN packet.

Depending on the embodiment, the WPAN sub-system 170 may establish multiple transmitter-receiver (TX-RX) pairs. In particular, the WPAN sub-system 170 as a central device may be communicatively coupled with multiple peripheral devices (e.g., various other WPAN sub-system and/or devices). The WPAN sub-system 170 may communicate with the multiple peripheral devices simultaneously. Each WPAN sub-system 170 and peripheral device of multiple peripheral devices establishes a single TX-RX pair. Accordingly, the time slot allocated for WPAN activity may be divided among the multiple TX-RX pairs.

During retransmission of the WPAN packet, coexistence management component 135 obtains from a set of bits of the various bits of the header containing more data that contains an identifier indicating whether another WPAN packet is expected from another TX-RX pair. If the set of bits indicates that another WPAN packet is expected from another TX-RX pair, coexistence management component 135 transmits another precise CTS-2-Self frame in which the expiration time is the same as the previous precise CTS-2-Self frame. Coexistence management component 135 repeats this process with every transmission of the WPAN packet within the time slot. In other words, for each transmission of a WPAN packet during the time slot, coexistence management component 135 determines, from a current WPAN packet, whether a subsequent WPAN packet is expected from another TX-RX pair and in response to determining a subsequent WPAN packet is expected transmitting a precise CTS-2-Self frame for the subsequent WPAN packet.

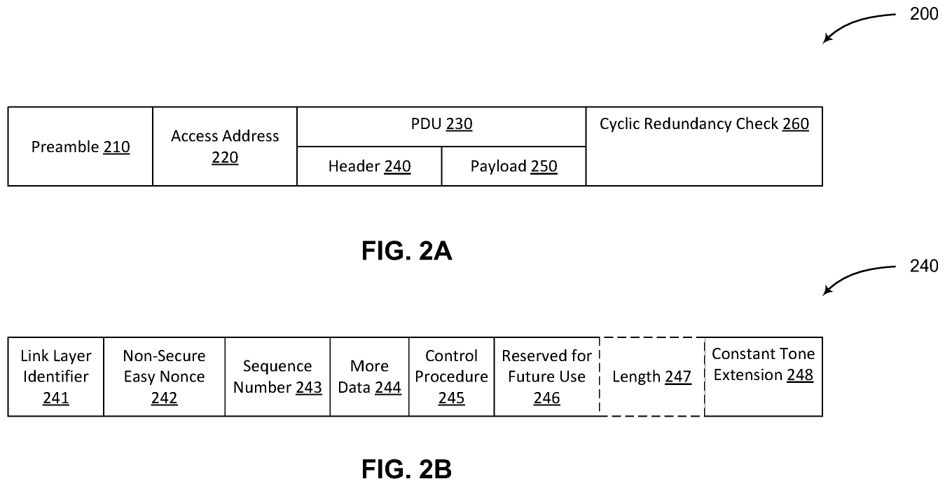

FIG. 2A is a block diagram of an exemplary WPAN packet 200, in accordance with implementations of the present disclosure. WPAN packet 200 may include a preamble 210, an access address 220, a protocol data unit (PDU) 230, and a cyclic redundancy check (CRC) 260. Preamble 210 refers to a sequence of bits sent at the beginning of the WPAN packet 200 to synchronize the receiver with the transmitter. The receiver uses the preamble to determine the start of the WPAN packet and to synchronize its clock with the clock of the transmitter. Access address 220, also known as a media access control (MAC) address refers to a unique identifier used to determine the intended recipient. CRC 260 refers to a method used to detect errors during transmission. More specifically, a short check value is appended to the end of the WPAN packet, which is calculated based on the data itself. When WPAN packet is received, the receiver recalculates the CRC value and compares it to the received one. If the values match, the data is considered error-free. If the values differ, an error is detected. PDU 230 includes header 240 and payload 250. PDU 230 refers to a basic unit of data that is transmitted and is composed of protocol-specific control information (e.g., header 240) and user data that is being transmitted (e.g., payload 250).

With reference to FIG. 2B, header 240 includes a link layer identifier (LLID) 241, a next expected sequence number (NESN) 242, a sequence number (SN) 243, more data (MD) 244, channel time extension (CTE) info present (CP) 245, reserved for future use (RFU) 246, length 247, and a constant tone extension (CTE) 248. LLID 241 indicates the type of frame, for example, a data frame, a control frame, etc. NESN 242 refers to the sequence number that is expected to be received next. If packets are received in order, the next expected sequence number will be the sequence number of the last packet received plus one. SN 243 refers to a number that is used to order frames so that a receiver can reassemble frames in the correct order. MD 244 refers to a flag that MD flag indicates whether there is more data to be transmitted for a TX-RX pair. If the MD flag is set, then there is more data to be transmitted in the next frame for the TX-RX pair. If the MD flag is cleared, then there is no more data to be transmitted. CP 245 indicates whether the data physical channel PDU header has a CTEInfo field and therefore whether the data physical channel packet has a CTE. If the CP field is 0, then no CTEInfo field is present in the data channel PDU header and there is no CTE in the data physical channel packet. If the CP field is 1, then the CTEInfo field in the data physical channel PDU header is present, and the data physical channel packet includes a CTE. RFU 246 refers to a set of bits that is not currently used but may be used in future versions of WPAN protocol. Length 247 indicates the payload length in bytes so that the receiver can allocate sufficient memory for the payload. CTE 248 may extend the length of the frame to allow the transmitter to send frames that are longer than the maximum payload length.

WPAN packet 200 is generated by WPAN sub-system 170. WPAN sub-system 170 generates WPAN packet 200 prepares the data (e.g., payload 250 of FIG. 2A) to be transmitted by formatting it into a suitable format for the WPAN protocol being used. WPAN sub-system 170 may further encrypt payload 250. WPAN sub-system 170 encapsulates header 240 and encrypted payload 250 in to PDU 230. WPAN sub-system 170 generates, based on the PDU 230, a CRC value and appends the CRC value to the end of the WPAN packet 200 as the CRC 260. WPAN sub-system 170 may perform data whitening of the PDU 230 and the CRC 260 of the WPAN packet 200 to reduce the correlation between consecutive symbols in a transmitted signal. data whitening uses a 7-bit linear feedback shift register (7-bit LFSR) to generate a pseudorandom noise (PRN) sequence. The PRN sequence is then used to XOR with the data (e.g., PDU 230 and/or CRC 260) to be transmitted, which encrypts the data.

As previously described, the expiration time of the sampling CTS-2-Self frame provides the coexistence management component 135 of FIG. 1 time to obtain the payload length. More specifically, in order to obtain information from length 247 of the WPAN packet 200, coexistence management component 135 of FIG. 1 monitors WPAN activity for the first transmission of the WPAN packet 200. Coexistence management component 135 performs data de-whitening. Data de-whitening refers to the process that reverses the data whitening process. It is used to recover the original data from a whitened portion of the WPAN packet 200. During data de-whitening, the receiver uses the same 7-bit LF SR to generate the PRN sequence and then XORs it with the received data (e.g., PDU 230 and the CRC 260) to decrypt it. Typically, in order to obtain the length information from header 240, data de-whitening may continue for a few bits after data de-whitening header 240 of the PDU 230. In particular, due to the use of the 7-bit LFSR, the data de-whitening process may have to wait another 7 bits after header 240 to obtain length 247.

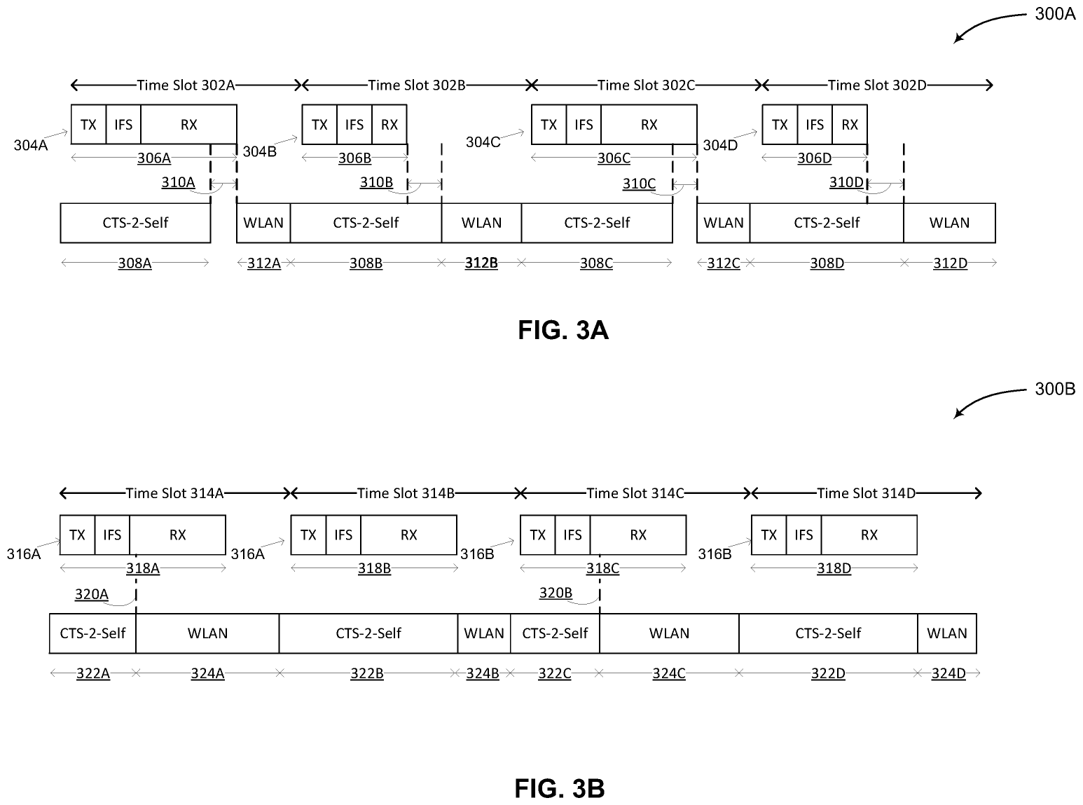

FIG. 3A depicts wireless activity over a shared medium 300A without the use of coexistence management component 135 of FIG. 1, in accordance with implementations of the present disclosure. As noted above, shared medium 300A may be divided into a plurality of time slots (e.g., time slot 302A-D).

During time slot 302A, WLAN sub-system 120, as a result of the execution of existing coexistence strategy by processor 140 of WLAN sub-system 120, monitors shared medium 300A for WPAN activity from WPAN sub-system 170. WLAN sub-system 120 identifies, from the WPAN activity, WPAN packet 304A. WLAN sub-system 120 may transmit a CTS-2-Self frame with an estimated expiration time 308A. WPAN packet 304A would require an actual expiration time 306A. The difference between actual expiration time 306A and estimated expiration time 308A results in a time difference 310A which causes under protection of the shared medium 300A. Activity of WLAN sub-system 120 takes over the shared medium 300A after the actual expiration time 306A for the remainder of time slot 302A (e.g., time duration 312A).

During time slot 302B, WLAN sub-system 120 monitors shared medium 300A for WPAN activity from WPAN sub-system 170. WLAN sub-system 120 identifies, from the WPAN activity, WPAN packet 304B. WLAN sub-system 120 may transmit a CTS-2-Self frame with an estimated expiration time 308B. WPAN packet 304B would require an actual expiration time 306B. The difference between actual expiration time 306B and estimated expiration time 308B results in a time difference 310B which causes over protection of the shared medium 300A. Activity of WLAN sub-system 120 takes over the shared medium 300A after the actual expiration time 306B for the remainder of time slot 302B (e.g., time duration 312B). In other words, time difference 310B could have been allocated to the activity of WLAN sub-system 120.

During time slot 302C, WLAN sub-system 120 monitors shared medium 300A for WPAN activity from WPAN sub-system 170. WLAN sub-system 120 identifies, from the WPAN activity, WPAN packet 304C. WLAN sub-system 120 may transmit a CTS-2-Self frame with an estimated expiration time 308C. WPAN packet 304C would require an actual expiration time 306C. The difference between actual expiration time 306C and estimated expiration time 308C results in a time difference 310C which causes under protection of the shared medium 300A. Activity of WLAN sub-system 120 takes over the shared medium 300A after the actual expiration time 306C for the remainder of time slot 302C (e.g., time duration 312C).

During time slot 302D, WLAN sub-system 120 monitors shared medium 300A for WPAN activity from WPAN sub-system 170. WLAN sub-system 120 identifies, from the WPAN activity, WPAN packet 304D. WLAN sub-system 120 may transmit a CTS-2-Self frame with an estimated expiration time 308D. WPAN packet 304D would require an actual expiration time 306D. The difference between actual expiration time 306D and estimated expiration time 308D results in a time difference 310D which causes over protection of the shared medium 300A. Activity of WLAN sub-system 120 takes over the shared medium 300A after the actual expiration time 306D for the remainder of time slot 302D (e.g., time duration 312D). In other words, time difference 310D could have been allocated to the activity of WLAN sub-system 120.

FIG. 3B depicts wireless activity over shared medium 300B, similar to shared medium 300A of FIG. 3A, with the use of coexistence management component 135 of FIG. 1, in accordance with implementations of the present disclosure. Shared medium 300B may be divided into a plurality of time slots (e.g., time slot 314A-D).

During time slot 314A, coexistence management component 135 monitors shared medium 300B for WPAN activity from WPAN sub-system 170. WLAN sub-system 120 identifies, from the WPAN activity, WPAN packet 316A. Coexistence management component 135 determines that the WPAN sub-system 170 has a slave latency that is not zero. Coexistence management component 135 determines that this is the first time WPAN packet 316A is transmitted. Coexistence management component 135 causes the WLAN sub-system 120 to transmit a sampling CTS-2-Self frame with an expiration time 322A. Expiration time 322A, as previously described, includes a transmission duration, IFS, and a reception duration for an empty payload. Coexistence management component 135 obtains a payload length from the header of the WPAN packet 316A prior to the end of expiration time 322A (e.g., time point 320A). WPAN activity on the shared medium 300B is interrupted by the WLAN sub-system 120 for WLAN activity for the remainder of time slot 314A (e.g., time duration 324A). WLAN activity may include transmitting a WPAN packet or a portion of the WPAN packet.

During time slot 314B, coexistence management component 135 monitors shared medium 300B for WPAN activity from WPAN sub-system 170. WLAN sub-system 120 identifies, from the WPAN activity, WPAN packet 316A. WPAN packet 316A would require an actual expiration time 318A. Coexistence management component 135 determines that this is not the first transmission of the WPAN packet 316A. Coexistence management component 135 causes the WLAN sub-system 120 to transmit a precise CTS-2-Self frame with an expiration time 322B. Expiration time 322B, as previously described, includes a transmission duration, IFS, and a reception duration associated with the payload length obtained from the header of the WPAN packet 316A transmitted during time slot 314A. The expiration time 322B is substantially equal to an actual expiration time 318B of the WPAN packet 316A. WPAN activity on the shared medium 300B is completed by the end of the expiration time 322B so that WLAN activity may take over the shared medium 300B for the remainder of time slot 314B (e.g., time duration 324B). In other words, there is no under or over protection of the shared medium 300B thus the WPAN sub-system 170 utilizes the time slot 314B for as long as it needs and before the WLAN sub-system 120 takes over and utilizes the remaining portion of time slot 314B.

During time slot 314C, coexistence management component 135 monitors shared medium 300A for WPAN activity from WPAN sub-system 170. WLAN sub-system 120 identifies, from the WPAN activity, WPAN packet 316B. WPAN packet 316B would require an actual expiration time 318C. Coexistence management component 135 determines that this is the first time WPAN sub-system 170 is transmitting WPAN packet 316B. Coexistence management component 135 causes the WLAN sub-system 120 to transmit a sampling CTS-2-Self frame with an expiration time 322C. Expiration time 322C, as previously described, includes a transmission duration, IFS, and a reception duration for an empty payload. Coexistence management component 135 obtains a payload length from the header of the WPAN packet 316B prior to the end of expiration time 322C (e.g., time point 320B). WPAN activity on the shared medium 300B is interrupted by the WLAN sub-system 120 for WLAN activity for the remainder of time slot 314C (e.g., time duration 324C). WLAN activity may include transmitting a WPAN packet or a portion of the WPAN packet.

During time slot 314D, coexistence management component 135 monitors shared medium 300A for WPAN activity from WPAN sub-system 170. WLAN sub-system 120 identifies, from the WPAN activity, WPAN packet 316B. Coexistence management component 135 determines that this is not the first transmission of the WPAN packet 316B. Coexistence management component 135 causes the WLAN sub-system 120 to transmit a precise CTS-2-Self frame with an expiration time 322D. Expiration time 322D, as previously described, includes a transmission duration, IFS, and a reception duration associated with the payload length obtained from the header of the WPAN packet 316B transmitted during time slot 314C. The expiration time 322D is substantially equal to an actual expiration time 318D of the WPAN packet 316B. WPAN activity on the shared medium 300B is completed by the end of the expiration time 322D so that WLAN activity may take over the shared medium 300B for the remainder of time slot 314D (e.g., time duration 324D). In other words, there is no under or over protection of the shared medium 300B thus the WPAN sub-system 170 utilizes the time slot 314D for as long as it needs and before the WLAN sub-system 120 takes over and utilizes the remaining portion of time slot 314D.

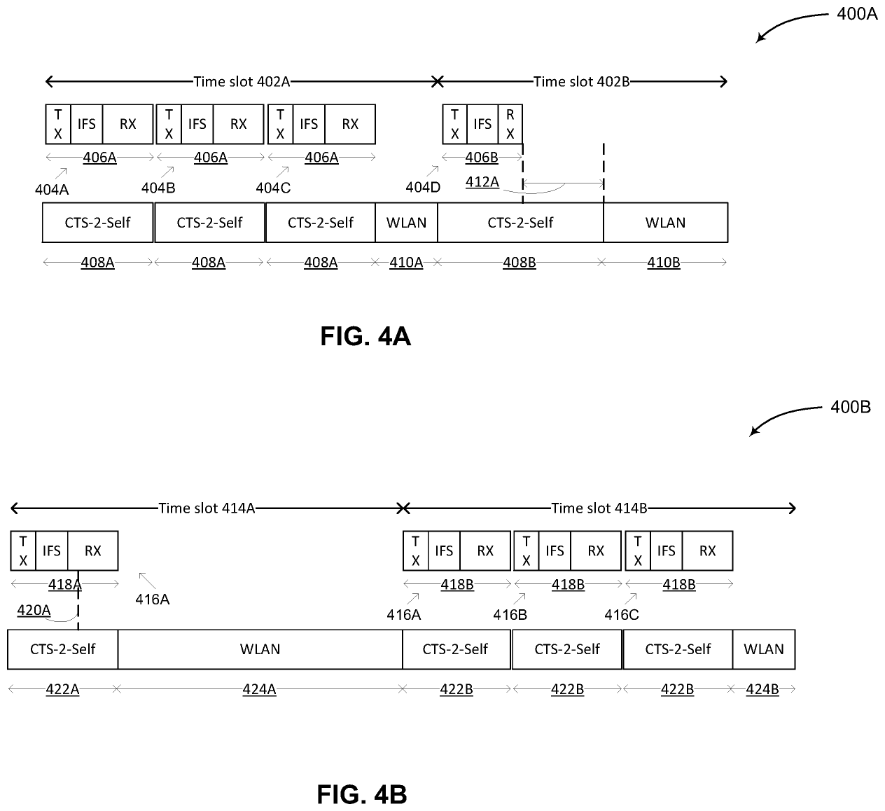

FIG. 4A depicts wireless activity over a shared medium 400A without the use of coexistence management component 135 of FIG. 1, in accordance with implementations of the present disclosure. As noted above, shared medium 400A may be divided into a plurality of time slots (e.g., time slot 402A-C).

During time slot 402A, WLAN sub-system 120 monitors shared medium 400A for WPAN activity from WPAN sub-system 170. WLAN sub-system 120 identifies, from the WPAN activity, multiple WPAN packets (e.g., WPAN packets 404A-C). WLAN sub-system 120 transmits, for each WPAN packet of the multiple WPAN packets, a CTS-2-Self frame with an estimated expiration time 408A. Each of the multiple WPAN packets (e.g., WPAN packets 404A-C) would require an actual expiration time 406A. Since the actual expiration time 306A matches the estimated expiration time 308A there is no under protection of the shared medium 400A. Activity of WLAN sub-system 120 takes over the shared medium 400A for the remainder of time slot 402A (e.g., time duration 410A).

During time slot 402B, WLAN sub-system 120 monitors shared medium 400A for WPAN activity from WPAN sub-system 170. WLAN sub-system 120 identifies, from the WPAN activity, WPAN packet 404D. WLAN sub-system 120 may transmit a CTS-2-Self frame with an estimated expiration time 408B. WPAN packet 404D would require an actual expiration time 406B. The difference between actual expiration time 406B and estimated expiration time 408B results in a time difference 412A which causes over protection of the shared medium 400A. Activity of WLAN sub-system 120 takes over the shared medium 400A for the remainder of time slot 402B (e.g., time duration 410B). In other words, time difference 412A could have been allocated to the activity of WLAN sub-system 120. Furthermore, in order for the WLAN sub-system to have uninterrupted access to shared medium 400A, the time duration 410A of time slot 402A and time duration 410B of time slot 402B could have been allocated in a single time slot to WLAN sub-system 120.

FIG. 4B depicts wireless activity over a shared medium 400B with the use of coexistence management component 135 of FIG. 1, in accordance with implementations of the present disclosure. As noted above, shared medium 400B may be divided into a plurality of time slots (e.g., time slot 414A-C).

During time slot 414A, coexistence management component 135 monitors shared medium 400B for WPAN activity from WPAN sub-system 170. WLAN sub-system 120 identifies, from the WPAN activity, WPAN packet 416A. WPAN packet 416A would require an actual expiration time 418B. Coexistence management component 135 determines that the WPAN sub-system 170 has a slave latency that is not zero. Coexistence management component 135 determines that this is the first time WPAN packet 416A is transmitted. Coexistence management component 135 causes the WLAN sub-system 120 to transmit a sampling CTS-2-Self frame with an expiration time 422A. Expiration time 422A, as previously described, includes a transmission duration, IFS, and a reception duration for an empty payload. Coexistence management component 135 obtains a payload length from the header of the WPAN packet 416A prior to the end of expiration time 422A (e.g., time point 420A). WPAN activity on the shared medium 400B is interrupted by the WLAN sub-system 120 for WLAN activity for the remainder of time slot 414A (e.g., time duration 424A). WLAN activity may include transmitting a WPAN packet or a portion of the WPAN packet.

During time slot 414B, coexistence management component 135 monitors shared medium 400B for WPAN activity from WPAN sub-system 170. WLAN sub-system 120 identifies, from the WPAN activity, WPAN packets 416A. Coexistence management component 135 determines that this is not the first transmission of the WPAN packet 416A. Coexistence management component 135 causes the WLAN sub-system 120 to transmit a precise CTS-2-Self frame with an expiration time 422B. Expiration time 422B, as previously described, includes a transmission duration, IFS, and a reception duration associated with the payload length obtained from the header of the WPAN packet 416A transmitted during time slot 414A. The expiration time 422B is substantially equal to an actual expiration time 418A of the WPAN packet 416A.

Coexistence management component 135 determines, from a header of the WPAN packet 416A retransmitted during time slot 414B, that another WPAN packet (e.g., WPAN packet 416B) of another TX-RX pair is expected. Coexistence management component 135 causes the WLAN sub-system 120 to transmit a precise CTS-2-Self frame with an expiration time 422B, same as the precise CTS-2-Self frame transmitted for WPAN packet 416A.

Coexistence management component 135 monitors shared medium 400B for WPAN activity from WPAN sub-system 170. WLAN sub-system 120 identifies, from the WPAN activity, WPAN packets 416B. WPAN packet 416B would require an actual expiration time 418B. Coexistence management component 135 determines, from a header of the WPAN packet 416B, that another WPAN packet (e.g., WPAN packet 416C) of another TX-RX pair is expected.

Coexistence management component 135 causes the WLAN sub-system 120 to transmit a precise CTS-2-Self frame with an expiration time 422B, same as the precise CTS-2-Self frame transmitted for WPAN packet 416A and WPAN packet 416B. WPAN packet 416C would require an actual expiration time 418B. Coexistence management component 135 monitors shared medium 400B for WPAN activity from WPAN sub-system 170. WLAN sub-system 120 identifies, from the WPAN activity, WPAN packets 416C. Coexistence management component 135 determines, from a header of the WPAN packet 416B, that no other WPAN packet is expected. WPAN activity on the shared medium 400B is completed by the end of the expiration time 422B of the precise CTS-2-Self frame transmitted for WPAN packet 416C so that WLAN activity may take over the shared medium 400B for the remainder of time slot 414B (e.g., time duration 424B). In other words, the shared medium 400B during the majority of time slot 414A was provided to WLAN sub-system 120 for uninterrupted activity. Additionally, there was no under or over protection of the shared medium 400B during time slot 414B, thus the WPAN sub-system 170 utilizes the time slot 414B for as long as it needs and before the WLAN sub-system 120 takes over and utilizes the remaining portion of time slot 414B.

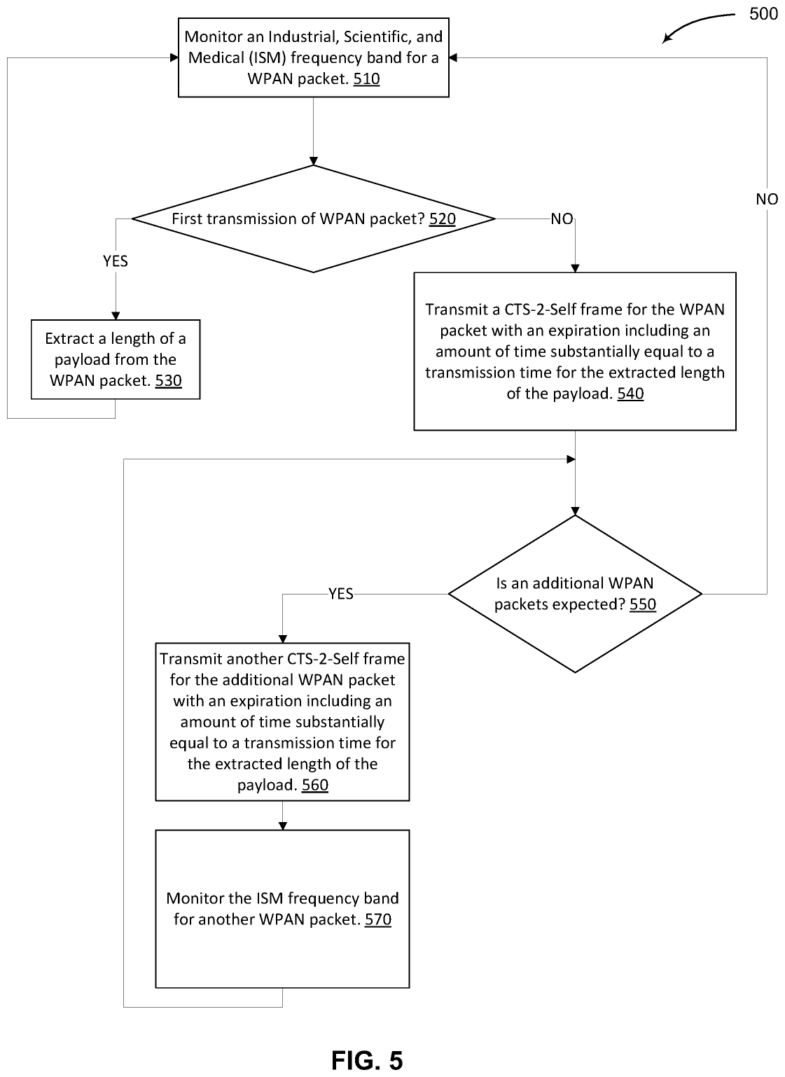

FIG. 5 depicts a flow diagram of an example method 500 for precise protection of shared medium based on payload length of a WPAN packet, in accordance with implementations of the present disclosure. Method 500 can be performed by processing logic that can include hardware (circuitry, dedicated logic, etc.), software (e.g., instructions run on a processor), or a combination thereof. In one implementation, some, or all of the operations of method 500 can be performed by one or more components of WLAN sub-system 120 of FIG. 1. In some embodiments, some, or all of the operations of method 500 can be performed by coexistence management 122 component 135 of FIG. 1, as described above.

At block 510, the processing logic monitors an ISM frequency band for a WPAN packet. The frequency band is divided into a plurality of time slots. In particular, the processing logic monitors the frequency band for WPAN activity from a WPAN sub-system of a wireless device (e.g., a first WPAN sub-system). The WPAN activity from the WLAN sub-system includes WPAN packet transmitted during a time slot of the frequency band. During WPAN activity, the processing logic transmits a CTS-2-Self frame including an expiration time in which the reception duration corresponds to an empty packet (e.g., sampling CTS-2-Self frame). As previously described, the sampling CTS-2-Self frame includes the transmission duration, the IFS, and the reception duration necessary for a receiver (e.g., a second WLAN sub-system) to receive the payload of the WPAN packet.

At block 520, the processing logic determines whether WPAN packet is the first transmission of the WPAN packet. As previously described, to determine that the WPAN packet is being transmitted for the first time (e.g., first transmission) includes identifying, from WPAN packet, whether a sequence number is zero or whether a retransmission flag is set to zero.

If it is determined that the WPAN packet is being transmitted for the first time (e.g., first transmission of the WPAN packet), at block 530, the processing logic obtains a length of a payload (e.g., payload length) from WPAN packet. As previously described, before the end of the expiration time of the sampling CTS-2-Self frame the payload length is obtained from a header of the WPAN packet which includes various bits including set of bits containing a payload length. Obtaining information from the header may include performing data de-whitening to access the set of bits of the header containing the payload length. At the end of the expiration time of the sampling CTS-2-Self frame, the WPAN activity is interrupted by the WLAN sub-system for WLAN activity (e.g., to transmit at least a portion of a WLAN packet) during the remainder of the time slot. The processing logic proceeds to block 510 to monitor the frequency band for a WPAN packet.

If it is determined that the WPAN packet is not being transmitted for the first time (e.g., second transmission of the WPAN packet or retransmission of the WPAN packet), at block 540, the processing logic transmits a CTS-2-Self frame for the WPAN packet with an expiration time including an amount of time substantially equal to a reception time for the obtained length of the payload (e.g., precise CTS-2-Self frame). As previously described, the precise CTS-2-Self frame includes the transmission duration, the IFS, and the reception duration necessary for a receiver to receive the payload of the re-transmitted packet. For example, the reception duration necessary for a receiver to receive the payload of the re-transmitted packet may be calculated by based on the payload length received from the previous transmission of the WPAN packet and a transmission rate. The precise CTS-2-Self frame is transmitted prior to, or during retransmission of the WPAN packet by the WLAN sub-system.

At block 550, the processing logic determines whether an additional WPAN packet is expected. The processing logic obtains, from a header of the second transmission of the WPAN packet (or retransmission of the WPAN packet), an indication that another WPAN packet is expected from another TX-RX pair (e.g., connection between the first WLAN sub-system and a third WLAN sub-system).

If it is determined that an additional WPAN packet is expected, the processing logic, at block 560, transmits another CTS-2-Self frame for the additional WPAN packet, with an expiration time including an amount of time substantially equal to a reception time for the obtained length of the payload. The processing logic proceeds to block 570 to monitor the frequency band (e.g., an ISM frequency band) for another WPAN packet. If it is determined that an additional WPAN packet is not expected, the processing logic, proceeds to block 510 to monitor the frequency band for a WPAN packet.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” or “sub-system” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
monitoring, by a wireless local area network (WLAN) sub-system of a wireless device, a frequency band for wireless personal area network (WPAN) activity;
identifying, from the WPAN activity, a first WPAN packet transmitted during a first time slot;
obtaining, from first WPAN packet, a payload length of the first WPAN packet; and
interrupting, by the WLAN sub-system, the WPAN activity to transmit at least a portion of a first WLAN packet within a remainder of the first time slot.

2. The method of claim 1, further comprising:
transmitting, based on the payload length of the first WPAN packet, a first clear to send to self (CTS-2-Self) frame with an expiration time that includes an amount of time substantially equal to a time it takes for a receiver of the first WPAN packet to receive the first WPAN packet based on the payload length.

3. The method of claim 2, further comprising:
obtaining, from a retransmission of the first WPAN packet during a second time slot, an identifier indicating whether a second WPAN packet is expected from a first transmitter-receiver pair (Tx-Rx pair) of a multiple Tx-Rx pairs of the WLAN sub-system; and
in response to determining that the second WPAN packet is expected, transmitting, during the second time slot after the first CTS-2-Self frame, a second CTS-2-Self frame with an expiration time that includes an amount of time substantially equal to a time it takes for a receiver of the first WPAN packet to receive the first WPAN packet based on the payload length.

4. The method of claim 3, further comprising:
obtaining, from the second WPAN packet transmitted during the second time slot, an identifier indicating whether a third WPAN packet is expected from a second Tx-Rx pair of the multiple Tx-Rx pairs of the WLAN sub-system; and
in response to determining that the third WPAN packet is expected, transmitting, during the second time slot after the second CTS-2-Self frame, a third CTS-2-Self frame with an expiration time that includes an amount of time substantially equal to a time it takes for a receiver of the first WPAN packet to receive the first WPAN packet based on the payload length.

5. The method of claim 3, wherein during a remainder of the second time slot the WLAN sub-system transmits at least a portion of a second WLAN packet.

6. The method of claim 1, wherein obtaining the payload length of the first WPAN packet comprises:
identifying, from a header of the first WPAN packet, a first set of bits containing payload length; and
obtaining, from the first set of bits containing payload length, the payload length.

7. The method of claim 6, wherein identifying, from the header of the first WPAN packet, the first set of bits includes performing data de-whitening.

8. The method of claim 3, wherein obtaining the identifier indicating whether the second WPAN packet is expected from the Tx-Rx pair of the multiple Tx-Rx pairs of the WLAN sub-system comprises:
obtaining, from a header of retransmission of the first WPAN packet, a second set of bits containing the identifier indicating whether an additional WPAN packet is expected within a current time slot.

9. A wireless local area network (WLAN) sub-system, comprising:
a processor; and
a memory comprising a coexistence management component, wherein the coexistence management component when executed by the processor is to perform operations comprising:
monitoring, by the WLAN sub-system, a frequency band for WPAN activity;
identifying, from the WPAN activity, a first WPAN packet transmitted during a first time slot;
obtaining, from first WPAN packet, a payload length of the first WPAN packet; and
interrupting, by the WLAN sub-system, the WPAN activity to transmit at least a portion of a first WLAN packet within a remainder of the first time slot.

10. The WLAN sub-system of claim 9, wherein the coexistence management component when executed by the processor is to perform operations further comprising:
transmitting, based on the payload length of the first WPAN packet, a first clear to send to self (CTS-2-Self) frame with an expiration time that includes an amount of time substantially equal to a time it takes for a receiver of the first WPAN packet to receive the first WPAN packet based on the payload length.

11. The WLAN sub-system of claim 10, wherein the coexistence management component when executed by the processor is to perform operations further comprising:
obtaining, from a retransmission of the first WPAN packet during a second time slot, an identifier indicating whether a second WPAN packet is expected from a first transmitter-receiver pair (Tx-Rx pair) of a multiple Tx-Rx pairs of the WLAN sub-system; and
in response to determining that the second WPAN packet is expected, transmitting, during the second time slot after the first CTS-2-Self frame, a second CTS-2-Self frame with an expiration time that includes an amount of time substantially equal to a time it takes for a receiver of the first WPAN packet to receive the first WPAN packet based on the payload length.

12. The WLAN sub-system of claim 11, wherein the coexistence management component when executed by the processor is to perform operations further comprising:
obtaining, from the second WPAN packet transmitted during the second time slot, an identifier indicating whether a third WPAN packet is expected from a second Tx-Rx pair of the multiple Tx-Rx pairs of the WLAN sub-system; and
in response to determining that the third WPAN packet is expected, transmitting, during the second time slot after the second CTS-2-Self frame, a third CTS-2-Self frame with an expiration time that includes an amount of time substantially equal to a time it takes for a receiver of the first WPAN packet to receive the first WPAN packet based on the payload length.

13. The WLAN sub-system of claim 12, wherein the coexistence management component when executed by the processor is to perform operations further comprising.

14. The WLAN sub-system of claim 9, wherein obtaining the payload length of the first WPAN packet comprises:
identifying, from a header of the first WPAN packet, a first set of bits containing payload length; and
obtaining, from the first set of bits containing payload length, the payload length.

15. The WLAN sub-system of claim 14, wherein identifying, from the header of the first WPAN packet, the first set of bits includes performing data de-whitening.

16. The WLAN sub-system of claim 11, wherein obtaining the identifier indicating whether the second WPAN packet is expected from the Tx-Rx pair of the multiple Tx-Rx pairs of the WLAN sub-system comprises:
obtaining, from a header of retransmission of the first WPAN packet, a second set of bits containing the identifier indicating whether an additional WPAN packet is expected within a current time slot.

17. A wireless device comprising:
a wireless local area network (WLAN) sub-system comprising a processor, and
a wireless personal area network (WPAN) sub-system operating on a frequency band with the WLAN sub-system, wherein the processor of the WLAN sub-system is to perform operations comprising:
monitoring the frequency band for a connection event of a WLAN sub-system during a first time slot, wherein the connection event includes transmission of a plurality of WPAN packets;
obtaining, from a first WPAN packet of the connection event, a payload length of the first WPAN packet; and
interrupting the connection event to utilize the frequency band for a remainder of the first time slot.

18. The system of claim 17, wherein the processor of the WLAN sub-system is to perform operations further comprising:
transmitting, during re-transmission of the connection event within a second time slot, a clear to send to self (CTS-2-Self) frame for each WPAN packet of the connection event, each CTS-2-Self frame having a duration substantially equal to a time it takes for a receiver of the first WPAN packet to receive the first WPAN packet based on the payload length.

19. The system of claim 17, wherein obtaining the payload length of the first WPAN packet comprises:
identifying, from a header of the first WPAN packet, a set of bits containing payload length; and
obtaining, from the set of bits containing payload length, the payload length.

20. The system of claim 17, wherein interrupting the connection event to utilize the frequency band for the remainder of the first time slot comprises:
determining, based on a parameter of the WLAN sub-system, whether a predetermined number of connection intervals may be skipped; and
in response to determining that at least one number of connection intervals may be skipped, interrupting the connection event.
